(19) United States
(12) Patent Application Publication
(10) Pub. No.: US 2007/0260892 A1
(43) Pub. Date: Nov. 8, 2007

(54) System and method for authenticating a power source

(76) Inventors: Christopher R. Paul, Bayport, NY (US); Joseph Cabana, Centereach, NY (US)

Correspondence Address: FAY KAPLUN & MARCIN, LLP, 15O BROADWAY, SUITE 702, NEW YORK, NY, 10038, US

(21) Appl. No.: 11/430,474

(22) Filed: May 8, 2006

(51) Int. Cl. G06F 12/14

(52) U.S. Cl. 713/193

(57) ABSTRACT

Described is a system and method for authenticating a power source. The system comprises a battery including a first encryption engine storing a first key and a computing device including a microcontroller and a second encryption engine storing a second key. When the microcontroller detects a coupling of the battery to the computing device, the microcontroller issues a challenge to the first encryption engine and the second encryption engine. The first encryption engine generates the first response as a function of the challenge, the first key and a predefined algorithm, and the second encryption engine generates the second response as a function of the challenge, the second key and the predefined algorithm. The microcontroller compares the first and second responses to authenticate the battery.

### FIELD OF THE INVENTION

The present invention relates generally to systems and methods for authenticating a power source.

### BACKGROUND

A conventional wireless device typically utilizes a rechargeable battery as a power source when it is not coupled to a line voltage. If the battery is not completely charged when a user intends to use the device, the user may swap the battery for a different, fully charged battery. While the battery intended for use with the device may be interchangeable with similar batteries (e.g., same model), the different battery may be intended for use with a different device or have different settings/properties incompatible with the device, which may cause structural and/or electrical damage to the device. For example, if the different battery is not capable of receiving the same charging voltage and charging rate from the device as the original battery, the different battery may explode, irreparably damaging the device and potentially causing harm to the user. Thus, there is a need to ensure authenticity of a power source provided for use with the device.

### SUMMARY OF THE INVENTION

The present invention relates to a system and method for authenticating a power source. The system comprises a battery including a first encryption engine storing a first key and a computing device including a microcontroller and a second encryption engine storing a second key. When the microcontroller detects a coupling of the battery to the computing device, the microcontroller issues a challenge to the first encryption engine and the second encryption engine. The first encryption engine generates the first response as a function of the challenge, the first key and a predefined algorithm, and the second encryption engine generates the second response as a function of the challenge, the second key and the predefined algorithm. The microcontroller compares the first and second responses to authenticate the battery.

### DESCRIPTION OF THE DRAWINGS

FIG. 1 shows an exemplary embodiment of a system for authenticating a power source according to the present invention.

FIG. 2 shows an exemplary embodiment of a method for authenticating a power source according to the present invention.

FIG. 3 shows an exemplary embodiment of a battery according to the present invention.

### DETAILED DESCRIPTION

The present invention may be further understood with reference to the following description and the appended drawings, wherein like elements are referred to with the same reference numerals. The present invention describes a system and method for authenticating a power source. While the exemplary embodiments of the present invention will be described with reference to the power source of a wireless device, those of skill in the art will understand that the present invention may be utilized by any device which utilizes a battery at least as a contingent source of power, e.g., the device uses a line voltage as a primary power source and uses the battery when the line voltage is removed/terminated.

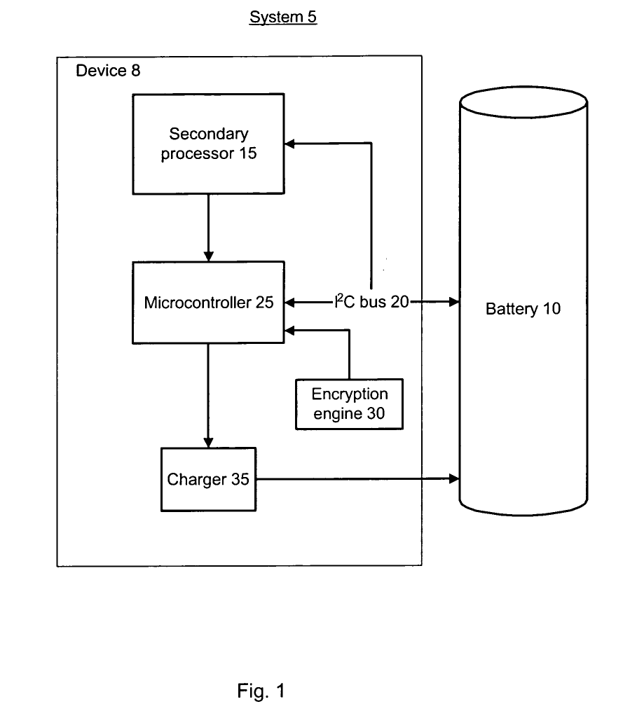

FIG. 1 shows an exemplary embodiment of a system 5 according to the present invention in which the system 5 is implemented in a mobile computing device 8 such as, for example, a laser-/imager-based scanner, an RFID reader, a mobile phone, a PDA, a tablet, a laptop, a portable media player, etc. The device 8 utilizes a rechargeable battery 10 as its primary power source when it does not receive power from an external power source, e.g., a line voltage, a USB port/hub, a solar cell, etc. As understood by those of skill in the art, when the device is coupled to, for example, the line voltage, the line voltage is used as the primary power source of the device 8 and for charging the battery 10. While the exemplary embodiments will be described with reference to the rechargeable battery 10, those of skill in the art will understand that the present invention may be similarly implemented for a single-use battery (e.g., an alkaline battery).

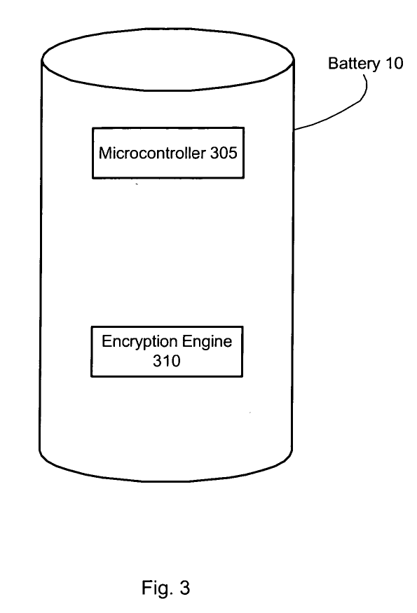

In the exemplary embodiments, the battery 10, as shown in FIG. 3, may be a smart battery which utilizes an integrated circuit to report and/or make available battery data to the device 8. The battery 10 may include a microcontroller 305 and an encryption engine 310. As will be described further below, the encryption engine 310 executed a predetermined algorithm on a stored battery key in response to a request from the device 8 to authenticate the battery 10. The battery data may include, but is not limited to, a battery type, a model number, a serial number, a manufacturer identifier, a discharge rate, a predicted remaining capacity, a temperature and a voltage. The battery 10 may also provide an almost-discharged alarm when the battery 10 is almost completely discharged, allowing the device 8 to execute a proper shutdown procedure to prevent loss and/or corruption of data stored on the device 8.

The device 8 includes a conventional primary processor (not shown) which executes applications and interfaces with components of the device 8 (e.g., a memory, a radio transceiver, a display screen, a keypad, a speaker, a microphone, etc.). As known by those of skill in the art, the primary processor typically consumes a significant amount of power from the battery 10, and, as such, may be powered down at predetermined times to conserve power. When the primary processor is powered down, the device 8 is in a power-save mode, but a secondary processor 15 remains powered, maintaining selected operations of the device 8 while consuming substantially less power from the battery 10. In the exemplary embodiments, the secondary processor 15 is a small processor which remains powered whether the primary processor is powered or the device 8 is in the power-save mode.

The secondary processor 15 may perform various functions on the device 8 including, for example, receiving and processing the battery data from the battery 10. The secondary processor 15 may communicate with the battery 10 on a serial bus, e.g., an I²C bus 20. As is known in the art, the I²C bus 20 is useful for coupling low-speed peripherals (e.g., the battery 10) to a motherboard and/or embedded system (e.g., the secondary processor 15). The I²C bus 20 allows the secondary processor 15 to read the battery data from hardware monitors, sensors, memory, etc. on the battery 10. As will be described further below, the secondary processor 15 interfaces with the battery 10 over the I²C bus 20 during the authentication process.

Those of skill in the art will understand that the primary processor (or any other microprocessor or controller) may implement the present invention.

In the exemplary embodiment, the device 8 further includes a microcontroller 25 and an encryption engine 30. As will be described further below, the microcontroller 25 and the encryption engine 30 are used to authenticate the battery 10. The device 8 further includes a charger 35 which, when the device 8 is coupled to the line voltage, charges the battery 10.

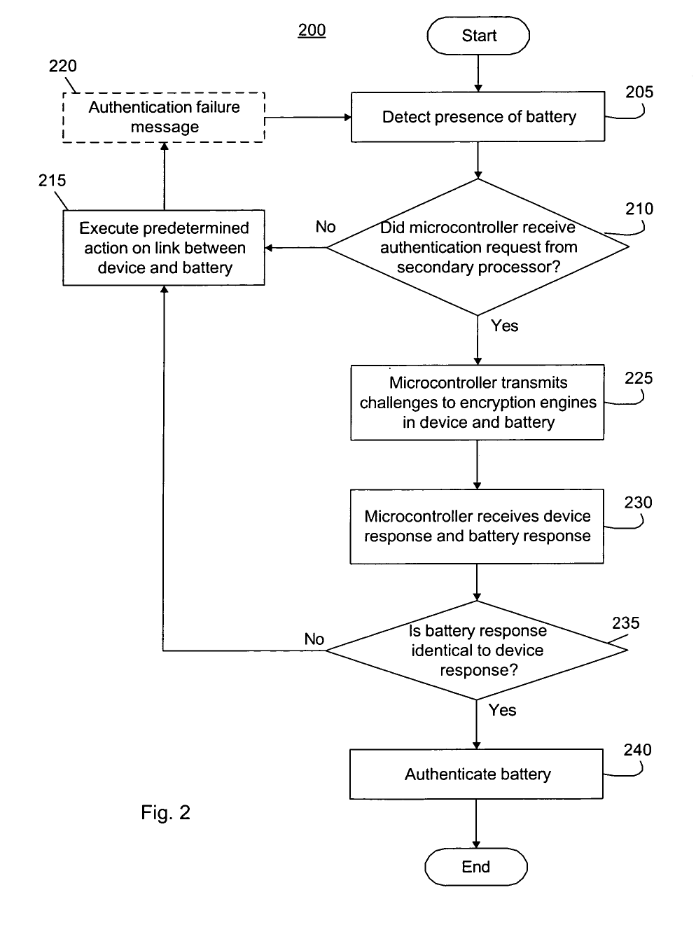

FIG. 2 shows an exemplary embodiment of a method 200 for authenticating the battery 10 according to the present invention. In step 205, the device 8 detects a presence of the battery 10 by, for example, detecting closure of a battery compartment door and/or latch which secures the battery 10 to the device 8. A switch may be deposed on a battery compartment so that when the battery compartment door is closed or the latch secures the battery 10 to a housing of the device 8, a coupling signal is sent to the secondary processor 15 and the microcontroller 25. The presence of the battery 10 may also be detected by monitoring signals on electrical contacts between the device 8 and the battery 10. Those of skill in the art will understand that any mechanical, electrical, optical, etc. means may be used to detect the coupling of the battery 10 to the device 8.

In step 210, the microcontroller 25 determines whether it has received an authentication request from the secondary processor 15 within a predetermined time of detecting the presence of the battery 10. When the microcontroller 25 receives the coupling signal, it initiates a count for the predetermined time during which it expects to receive the authentication request from the secondary processor 15. The microcontroller 25 may not receive the authentication request when, for example, the secondary processor 15 determines that the battery 10 is not intended to be used with the device 8, e.g., the initialization handshake fails.

If the microcontroller 25 does not receive the authentication request in the predetermined time, the microcontroller 25 may execute a predetermined action to impair a link between the device and the battery 10, as shown in step 215. For example, the microcontroller 25 may lock the I²C bus 20 preventing the secondary processor 15 from receiving any further battery data, e.g., the battery data described above, battery fuel gauge information, current state of charge, etc. The microcontroller 25 may also disable or selectively impair the charger 35. If the charger 35 is disabled, the battery 10 will not charge when the device 8 is coupled to the external power source. If the charger 35 is selectively impaired, the charger 35 may supply power to the battery 10 at a predetermined charge rate which is selected so that the battery 10 never becomes fully charged, rendering it useless as a power source for the device 8. Alternatively, the predetermined charge rate (e.g., a charge current level) may be selected to ensure that the battery 10 does not explode, i.e., a very slow charge rate. In addition, the microcontroller 25 or the secondary processor 15 may cause the battery 10 to be partially or completely ejected from the device 8.

In optional step 220, an authentication failure message (e.g., text on the display screen, LED color change/blink sequence, audible signal, etc.) may be output by the device 8 to indicate to the user that the battery 10 was not authenticated. The authentication failure message may prompt the user to replace the battery 10. When the battery door is opened and then re-closed, the method 200 will repeat itself.

When the microcontroller 25 receives the authentication request from the secondary processor 15 within the predetermined time, the microcontroller 25 generates a challenge to obtain a device response from the encryption engine 30 and a battery response from the encryption engine 310 in the battery 10, as shown in step 225. For example, the encryption engine 30 stores a device key, and, when instructed to do so by the microcontroller 25, generates the device response based on the challenge, a predefined algorithm (e.g., CRC, SHA-1, etc.) and the device key. In the exemplary embodiments, the predefined algorithm is publicly known and the device key is secret. The device response is strongly influenced by the device key and the challenge, but it would be mathematically impossible to discover the device key even with knowledge of the device response, the challenge and the predefined algorithm.

In step 230, the microcontroller 25 receives the device response from the encryption engine 30 and the battery response from the battery 10. The encryption engine 310 in the battery 10 generates the battery response based on the challenge, the predefined algorithm and a battery key. The predefined algorithm may be the same publicly known algorithm used by the encryption engine 30 to generate the device response. As described above with reference to the device response, the battery response may be strongly influenced by the battery key and the challenge, but it would be mathematically impossible to discover the battery key even with knowledge of the battery response, the challenge and the predefined algorithm.

In step 235, the microcontroller 25 determines whether the battery response is identical to the device response. When the responses are not identical, the microcontroller 25 may execute the predetermined action on the link between the device 8 and the battery 10, as described above with reference to step 220. When the responses are identical, the microcontroller 25 may assume (without ever expressly knowing) that the battery key is identical to the device key and authenticate the battery 10, as shown in step 240.

In the exemplary embodiment, the encryption engine 30 generates a single device response based on a single device key which is compared to a single battery response based on a single battery key. In other exemplary embodiments, the device response may be used to authenticate a plurality of batteries. For example, the device 8 may be capable of utilizing a plurality of batteries having a same model number. In this embodiment, the encryption engine 30 may store a plurality of device keys and select a particular device key based on, for example, the battery data (e.g., a model number of the battery 10), the battery response, etc. The resultant device response may be used to authenticate any battery with the model number. Those of skill in the art will understand that various modifications may be made to the response generation/encryption and/or response matching processes which would not depart from the overall scope of authenticating the battery 10 by the device 8 according to the present invention.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A system, comprising:
a battery including a first encryption engine storing a first key; and
a computing device including a microcontroller and a second encryption engine storing a second key,
wherein, when the microcontroller detects a coupling of the battery to the computing device, the microcontroller issues a challenge to the first encryption engine and the second encryption engine,
wherein the first encryption engine generates the first response as a function of the challenge, the first key and a predefined algorithm, and the second encryption engine generates the second response as a function of the challenge, the second key and the predefined algorithm, and
wherein the microcontroller compares the first and second responses to authenticate the battery.

2. The system according to claim 1, wherein the predefined algorithm is one of CRC and SHA-1.

3. The system according to claim 1, wherein, when the first and second responses are identical, the microcontroller authenticates the battery.

4. The system according to claim 1, wherein, when the first and second responses are different, the microcontroller executes a predetermined action to impair a link between the computing device and the battery.

5. The system according to claim 4, wherein the predetermined action is at least one of (i) locking a communication bus over which the computing device receives data from the battery, (ii) disabling a charger in the computing device which supplies power to the battery, (iii) lowering a charge current level and (iv) at least partially ejecting the battery from the computing device.

6. The system according to claim 1, wherein the computing device is one of an imager-based scanner, a laser-based scanner, an RFID reader, a PDA, a mobile phone, a tablet, a portable media player and a camera.

7. The system according to claim 1, wherein the battery is a rechargeable smart battery.

8. A device, comprising:
an encryption engine storing a first key; and
a microcontroller detecting a coupling of a battery to the device, the microcontroller issuing a challenge to the encryption engine to obtain a first response and to a further encryption engine on the battery to obtain a second response, the further encryption engine storing a second key,
wherein the encryption engine generates the first response using a predefined algorithm, the challenge and the first key, and the further encryption engine generates the second response using the predefined algorithm, the challenge and the second key, and
wherein the microcontroller compares the first and second responses to authenticate the battery.

9. The device according to claim 8, wherein the predefined algorithm is one of CRC and SHA-1.

10. The device according to claim 8, wherein, when the first and second responses are identical, the microcontroller authenticates the battery.

11. The device according to claim 8, wherein, when the first and second responses are different, the microcontroller executes a predetermined action to impair a link between the device and the battery.

12. The device according to claim 11, wherein the predetermined action is at least one of (i) locking a communication bus over which the device receives data from the battery and (ii) disabling a charger in the device which supplies power to the battery, (iii) lowering a charge current level and (iv) at least partially ejecting the battery from the computing device.

13. The device according to claim 8, wherein the device is one of an imager-based scanner, a laser-based scanner, an RFID reader, a PDA, a mobile phone, a tablet, a portable media player and a camera.

14. The device according to claim 8, wherein the battery is a rechargeable smart battery.

15. A method, comprising:
detecting a coupling of a battery to a computing device, the computing device including a first encryption engine storing a first key, the battery including a second encryption engine storing a second key;
issuing a challenge to the first encryption engine to obtain a first response, the first response being generated as a function of the challenge, the first key and a predefined algorithm;
issuing the challenge to the second encryption engine to obtain a second response, the second response being generated as a function of the challenge, the second key and the predefined algorithm; and
comparing the first and second responses to authenticate the battery.

16. The method according to claim 15, wherein the predetermined algorithm is one of CRC and SHA-1.

17. The method according to claim 15, further comprising:
when the first and second responses are different, impairing a link between the computing device and the battery.

18. The method according to claim 17, wherein the impairing step includes at least one of the following substeps:
locking a communication bus over which the computing device receives data from the battery; and
disabling a charger in the computing device which supplies power to the battery.

19. A battery, comprising:
a communications arrangement interfacing with a computing device; and
an encryption engine receiving an authentication challenge from the computing device, the encryption engine storing a key, the encryption engine generating an authentication response as a function of the authentication challenge, a predefined algorithm and the key,
wherein the communications arrangement transmits the response to the computing device to be authenticated thereby.

20. The battery according to claim 19, wherein the predefined algorithm is one of CRC and SHA-1.

21. A device, comprising:
an encryption means storing a first key; and
a processing means detecting a coupling of a battery to the device, the processing means issuing a challenge to the encryption means to obtain a first response and to a further encryption means on the battery to obtain a response, the further encryption means storing a second key,
wherein the encryption means generates the response using a predefined algorithm, the challenge and the first key, and the further encryption means generates the response using the predefined algorithm, the challenge and the second key, and
wherein the processing means compares the first and second responses to authenticate the battery.
